(19) United States
(12) Patent Application Publication
(10) Pub. No.: US 2026/0018308 A1
(43) Pub. Date: Jan. 15, 2026

(54) METHOD AND DEVICE FOR NUCLEAR FUSION WITH DEUTERIUM ALLOY REACTOR

(71) Applicant: Wentao DAI, Shenzhen (CN)

(72) Inventor: Wentao DAI, Shenzhen (CN)

(21) Appl. No.: 19/333,483

(22) Filed: Sep. 19, 2025

Related U.S. Application Data
(63) Continuation-in-part of application No. 18/211,319, filed on Jun. 19, 2023.
Application No. 18/211,319 is a continuation of application No. PCT/CN2023/072326, filed on Jan. 16, 2023.

(30) Foreign Application Priority Data
Mar. 31, 2022 (CN) 202210328944.6

(51) Int. Cl. G21B 1/19; G21B 1/17

(52) U.S. Cl. CPC G21B 1/19; G21B 1/17

(57) ABSTRACT

A method and a device for nuclear fusion with a deuterium alloy reactor are provided. The device includes: a high-energy neutron generator unit for generating a high-energy neutron current to bombard densely confined static deuterons in the deuterium alloy, producing high-energy deuterium nuclei; a deuterium alloy reactor unit, where deuterium gas forms a deuterium alloy upon entering the reactor, when bombarded by an external high-energy neutron current, high-energy deuterium nuclei are generated, the high-energy deuterium nuclei collide with tightly confined static deuterium nuclei in the deuterium alloy reactor, overcoming a Coulomb barrier and undergoing a nuclear fusion reaction; the high-energy deuterium nuclei further collide violently with the high-energy tritium nuclei produced by the nuclear fusion reaction to continue the nuclear fusion reaction; and an energy conversion unit configured to convert energy generated by the nuclear fusion reaction into usable energy.

### TECHNICAL FIELD

The disclosure relates to the technical field of nuclear fusion, and in particular relates to a method and a device for nuclear fusion with a deuterium alloy reactor.

### BACKGROUND

Since James Watt invented the first steam engine in 1769, mankind entered the era of internal combustion engines. Petroleum, as “industrial blood”, has supported the rapid development of mankind for more than two hundred years. However, the excessive exploitation and use of fossil fuels cause the following problems: (1) carbon emission levels remain high and the global ecological environment is seriously damaged, and (2) fossil fuel resources are increasingly depleted. Therefore, it is urgent for mankind to promote the replacement of petroleum energy by clean energy.

The controlled nuclear fusion technique has a high energy efficiency ratio (EER), involves the raw materials of hydrogen, deuterium, and tritium that exist in large quantities in nature, and can lead to permanent clean energy for human beings. As a result, the controlled nuclear fusion technique has become an important exploration direction of new energy in countries worldwide.

Currently, the human research on controlled nuclear fusion is conducted mainly by a tokamak device, which mainly has the following disadvantages:
1. Tn the high-temperature plasma of fusion materials, deuterium nuclei are extremely sparse, resulting in a low probability of nuclear collisions and fusion; self-sustaining fusion reactions are easily interrupted by decreases in density or temperature.
2. The entire fusion device must be heated to temperatures exceeding 100,000,000° C., requiring enormous input energy and resulting in a relatively low Q-value for the fusion reaction.
3. The tokamak device is very bulky and inconvenient to construct and transport.

### SUMMARY

An objective of the disclosure is to solve the above technical problems and provide a method and a device for nuclear fusion with a deuterium alloy reactor. \textcircled{1} This nuclear fusion method employs a lithium deuteride (or erbium) alloy reactor, enabling dense storage of deuteron nuclei. Each cubic meter of the alloy reactor can store deuterium gas equivalent to 1,125 cubic meters, thereby significantly increasing the probability of deuteron collisions and nuclear fusion reactions. \textcircled{2} By utilizing a high-energy neutron current of 1.2 MeV or above to continuously bombard the densely confined deuteron nuclei within the deuterium alloy reactor, high-energy deuterons of 1.2 MeV or higher are persistently generated. This process maintains the temperature in the fusion reaction zone (subjected to continuous bombardment by the ≥1.2 MeV neutron current) at and sustainably stabilizes it above 14 billion ° C. The 1.2 MeV high-energy deuterons continuously and violently collide with the statically confined deuteron nuclei in the alloy reactor, overcoming Coulomb repulsion and sustaining nuclear fusion reactions. As a result, the nuclear fusion process proceeds steadily and continuously. The disclosure overcomes the limitations of traditional controlled nuclear fusion, where self-sustaining fusion reactions are disrupted due to the low density of deuteron nuclei in plasma and temperature drops. It also addresses the excessive energy consumption associated with heating the entire fusion device to temperatures above 100 million ° C., as required in conventional approaches. The “deuterium alloy nuclear fusion reactor technology and device” described in the disclosure significantly enhances the Q-value and stability of nuclear fusion reactions, demonstrating substantial application prospects.

In the disclosure, a symbol of protium is P or 1H, a symbol of deuterium is D or 2H, and a symbol of tritium is T or 3H; and 1 MeV=1,000,000 eV.

To solve the above technical problems, the disclosure adopts the following technical solutions:

A device for nuclear fusion with a deuterium alloy reactor is provided, including: a high-energy neutron generator unit, configured to generate a high-energy neutron current of over 1.2 MeV; an alloy reactor unit, configured to store a deuterium gas to produce the deuterium alloy reactor and to allow a nuclear fusion reaction; and an energy conversion unit configured to convert energy generated by the nuclear fusion reaction into usable energy.

The neutron generator unit includes a proton source, an acceleration tube, a clustering tube, a vacuum valve, a target metal, and a control rod. The proton source includes a discharge tube in a cylindrical shape, a left end of the discharge tube is fixed with an insulating base and a hydrogen gas inlet pipe, a central axis position of the insulating base is disposed with a tungsten filament cathode, a right end of the discharge tube is sequentially disposed with a counter-cathode, an extraction electrode, and an acceleration electrode; a central axis of the counter-cathode is defined with a proton extraction hole, a wall of the discharge tube is disposed as an anode with electromagnetic coils therearound configured to generate an axial magnetic field directed to right when powered; a discharge power supply and a voltage-equalizing resistor are connected between the tungsten filament cathode and the anode, and the voltage-equalizing resistor is configured to adjust a discharge voltage; when the tungsten filament cathode is powered and heated, the tungsten filament cathode is configured to ionize hydrogen gas entering the discharge tube to produce glow discharge to thereby generate electrons and protons; the protons converge into a proton beam towards the proton extraction hole defined at the central axis of the counter-cathode under an action of an electric field force; the electrons are attracted by a radial electric field force of the anode and simultaneously influenced by an electromagnetic force of a magnetic field directed to the right, to thereby move in a spiral coil motion towards the wall of the of the discharge tube; during the spiral coil motion of the electrons, the electrons are configured to collide with more hydrogen atomic nuclei to ionize more protons and then converge into the proton beam towards the proton extraction hole defined at the central axis of the counter-cathode.

A left end of the acceleration tube is sequentially connected to the extraction hole and extraction electrode on the central axis of the counter-cathode, a right end of the acceleration tube is connected to the clustering tube, the left end and the right end of the acceleration tube are respectively connected to positive and negative poles of an acceleration power supply, and the acceleration power supply is configured to provide an acceleration voltage; the protons enter the acceleration tube through the proton extraction hole and the extraction electrode, and under an action of an electric field force of the acceleration electrode, the protons are accelerated to above 2.8 MeV to form high-energy protons.

The clustering tube and an emission end are sequentially arranged at the right end of the acceleration tube, multiple groups of electromagnetic coils are arranged around the clustering tube, a clustering magnetic field is generated with multiple groups of electromagnetic forces facing each other in opposite directions when the multiple groups of electromagnetic coils are electrified. Under the combined action of these electromagnetic forces, the high-energy proton current is further focused to form high-energy proton beams. The protons generated by the proton source are accelerated into high-energy protons of more than 2.8 MeV through the acceleration tube, the high-energy protons are focused through the clustering tube to form the high-energy proton beams of more than 2.8 MeV, and the high-energy proton beams are emitted from the emission end positioned at the right side of the clustering tube.

The target metal is also arranged on that right side of the emission end, a protective film is arranged on the surface of the target metal, and the target metal material can be prepared from materials such as beryllium, tungsten or mercury. The control rod is inserted into the target metal, the control rod can be a boron carbide control rod, when high-energy proton beam of more than 2.8 MeV emitted from the emission end bombard the target metal, the high-energy neutron current of more than 1.2 MeV can be generated. The speed and intensity of the high-energy neutron current can be adjusted by adjusting the depth of the boron carbide rod inserted into the target metal.

A right end of the target metal is equipped with the deuterium alloy reactor, the high-energy neutron current generated by the high-energy neutron generator unit bombards densely stored deuterium nuclei in the deuterium alloy reactor to generate high-energy deuterium nuclei of 1.2 MeV; the high-energy deuterium nuclei collide with tightly confined static deuterium nuclei in the deuterium alloy reactor, quickly overcome a Coulomb barrier and undergo a nuclear fusion reaction to produce high-energy tritium nuclei, thereby releasing energy; and the high-energy deuterium nuclei further collide violently with the high-energy tritium nuclei produced by the nuclear fusion reaction, overcome the Coulomb barrier to continue the nuclear fusion reaction and release energy.

The deuterium alloy reactor unit includes the deuterium alloy reactor, a cooling liquid loop, and a heat exchanger; the deuterium alloy reactor is made of deuterium storage alloy and an additive; a bottom of the deuterium alloy reactor is defined with a helium exhaust port, and a top of the deuterium alloy reactor is defined with a gas feed port configured to add deuterium gas raw materials; after storing deuterium gas, the deuterium alloy reactor forms deuterium alloy reactor modules, the deuterium alloy reactor modules are arranged to move to be sequentially struck by the high-energy neutron current, thereby producing the nuclear fusion reaction; the cooling liquid loop is disposed at a front side, a rear side, and a right side of the deuterium alloy reactor unit to prevent the deuterium alloy reactor modules from overheating and is configured to cool down and collect the energy; and the heat exchanger is disposed on the cooling liquid loop and configured to transfer the energy to the energy conversion unit.

In an embodiment, the deuterium alloy is prepared using lithium (Li) or erbium (Er); and the additive includes one or more selected from the group consisting of chromium (Cr), iron (Fe), manganese (Mn), cobalt (Co), nickel (Ni), and copper (Cu).

In an embodiment, a surface of the metal target is provided with a metal protective film; the control rod is a boron carbide control rod; and the control rod is inserted into the target metal and is configured to control speed and intensity of the high-energy neutron current by adjusting a depth of insertion of the control rod into the target metal.

In an embodiment, the proton source is provided with the discharge power supply configured to produce a pulsed proton current.

In an embodiment, the proton source further includes a high-voltage terminal shell and a voltage-equalizing resistor; the voltage-equalizing resistor is connected in series to a positive circuit of the discharge power supply; and the acceleration tube is further provided with a water-cooled coil for shell cooling.

In an embodiment, the acceleration tube is disposed with the acceleration electrode, and the clustering tube is configured to further focus the high-energy protons to obtain the high-energy proton beam.

In an embodiment, the target metal is one of beryllium (Be), tungsten (W), and mercury (Hg); when the high-energy proton beam bombards a Be target, a W target, or a Hg target, the high-energy neutron current of over 1.2 MeV is generated; and the corresponding nuclear reaction equations are as follows:
A. high-energy proton bombardment of the Be target:

$${}_{1}^{1} H + {}_{4}^{9} Be \to {}_{5}^{9} B + {}_{0}^{1} n ;$$

B. high-energy proton bombardment of the W target:

$${}_{1}^{1} H + {}_{74}^{184} W \to {}_{45}^{103} Rh + {}_{30}^{64} Zn + 18 \times {}_{0}^{1} n ;$$

C. high-energy proton bombardment of the Hg target:

$$2 \times {}_{1}^{1} H + {}_{80}^{200} Hg \to {}_{56}^{130} Ba + {}_{26}^{54} Fe + 18 \times {}_{0}^{1} n .$$

In an embodiment, the energy conversion unit is provided with a steam engine, and the steam engine includes a steam generator; and the energy conversion unit collects heat energy generated by nuclear fusion through the heat exchanger and cools a deuterium alloy reactor, then converts the collected heat energy into water vapor through the steam generator, and drives the steam engine to generate electricity through the water vapor, such that the heat energy is converted into electric energy.

A method for nuclear fusion with a deuterium alloy reactor is provided, including the following steps:
(1) taking Li or Er as a deuterium storage alloy, and taking one or more selected from the group consisting of Cr, Fe, Mn, Co, Ni, and Cu as an additive; filling a reaction chamber with inert gas, placing Li or Er metal powder in the reaction chamber, continuously extracting the inert gas and introducing deuterium gas, letting the deuterium gas and the Li or Er metal powder react continuously for several hours under certain temperature and pressure conditions to prepare lithium deuteride alloy or erbium deuteride alloy; and filling the lithium deuteride alloy or the erbium deuteride alloy into deuterium alloy modules to produce a lithium deuteride alloy reactor or an erbium deuteride alloy reactor as the deuterium alloy reactor;
the proton source generates protons by ionizing hydrogen gas; the protons are accelerated through an acceleration tube and formed into a high-energy proton beam via a clustering tube before striking the target metal; a vacuum valve is installed on the acceleration tube to evacuate it; a control rod is inserted into the target metal; the protons, after acceleration and clustering, form a high-energy proton beam which bombards the target metal to produce a high-energy neutron current; the control rod, made of boron carbide, is embedded in the target metal; speed and intensity of the high-energy neutron current generation are regulated by adjusting the depth of the control rod's insertion into the target metal;
(2) producing a high-energy neutron current by using a high-energy proton beam to bombard Be or W target metal, using the high-energy neutron current to bombard the lithium deuteride alloy reactor or the erbium deuteride alloy reactor in the step (1), such that deuterium nuclei in the deuterium alloy reactor are struck by high-energy neutrons to generate high-energy deuterium nuclei of 1.2 MeV; the high-energy deuterium nuclei collide with tightly confined static deuterium nuclei in the deuterium alloy reactor, quickly overcome a Coulomb barrier and undergo a nuclear fusion reaction; adjusting a depth of a control rod inserted into a target metal to control speed and intensity of the high-energy neutron current generated by the target metal, thereby controlling intensity of the nuclear fusion reaction;
(3) providing a cooling liquid loop outside the deuterium alloy reactor, wherein the cooling liquid loop is configured for cooling, collecting an energy generated by the nuclear fusion reaction, and delivering the energy to an energy conversion unit through a heat exchanger; and
(4) converting the energy generated by the nuclear fusion reaction in step (3) into a usable energy by the energy conversion unit.

In an embodiment, in the step (1), the Li or Er metal powder reacts with the deuterium gas to form the lithium deuteride alloy or the erbium deuteride alloy, with the respective reaction equations as follows:

$$\begin{matrix}2 \times {}_{3}^{6} ∠ i + {}_{1}^{2} {H}_{2} \to 2 \times {}_{3}^{6} ∠ i {}_{1}^{2} H ; or \\ 2 \times {}_{68}^{167} Er + 3 \times {}_{1}^{2} {H}_{2} \to 2 \times {}_{68}^{167} {Er}_{1}^{2} H 3.\end{matrix}$$

In an embodiment, the nuclear fusion reaction is specifically as follows:

In the lithium deuteride alloy reactor, equations of the nuclear fusion reaction are as follows:

$$2 \times {}_{3}^{6} ∠ i + {}_{1}^{2} {H}_{2} \to 2 \times {}_{3}^{6} ∠ i {}_{1}^{2} H \qquad 1$$

$${}_{0}^{1} n + {}_{3}^{6} Li \to {}_{2}^{4} He + {}_{1}^{3} H + 4.8 MeV \qquad 2$$

$${}_{1}^{2} H + {}_{1}^{3} H \to {}_{2}^{4} He + {}_{0}^{1} n + 17.6 MeV \qquad 3$$

$${}_{1}^{2} H + {}_{1}^{2} H \to {}_{1}^{3} H + {}_{1}^{1} H + 3.37 MeV \qquad 4$$

$${}_{0}^{1} n + {}_{3}^{6} Li \to {}_{2}^{4} He + {}_{1}^{3} H + 4.8 MeV \qquad 5$$

$${}_{1}^{2} H + {}_{3}^{6} ∠ i \to 2 \times {}_{2}^{4} He + 22.4 {M}_{e} V \qquad 6$$

$${}_{1}^{2} H + {}_{2}^{3} He \to {}_{2}^{4} He + {}_{1}^{1} H + 18.14 MeV \qquad 7$$

$${}_{1}^{2} H + {}_{1}^{2} H \to {}_{2}^{3} He + {}_{0}^{1} n + 3.37 MeV \qquad 8$$

In the erbium deuteride alloy reactor, equations of the nuclear fusion reaction are as follows:

$$2 \times {}_{68}^{167} Er + 3 \times {}_{1}^{2} {H}_{2} \to 2 \times {}_{68}^{167} {Er}_{1}^{2} H3 \qquad 1$$

$${}_{1}^{2} H + {}_{1}^{2} H \to {}_{2}^{3} He + {}_{0}^{1} n + 3.37 MeV \qquad 2$$

$${}_{1}^{2} H + {}_{2}^{3} He \to {}_{2}^{4} He + {}_{1}^{1} H + 18.14 MeV \qquad 3$$

$${}_{1}^{2} H + {}_{1}^{3} H \to {}_{2}^{4} He + {}_{0}^{1} n + 17.6 MeV \qquad 4$$

$${}_{1}^{2} H + {}_{1}^{2} H \to {}_{1}^{3} H + {}_{1}^{1} P + 4.04 MeV \qquad 5$$

$${}_{68}^{167} Er + {}_{1}^{1} P \to {}_{69}^{169} Tm . \qquad 6$$

In an embodiment, the control rod is a boron carbide control rod.

The method and device for nuclear fusion with a deuterium alloy reactor provided by the disclosure have the following beneficial effects:
1. The nuclear fusion method adopts a deuterium alloy reactor, and the deuterium alloy reactor can store 1,125 cubic meters of hydrogen, deuterium, and tritium per cubic meter. A density of the deuterium alloy reactor is 1,125 times a density of pure hydrogen, deuterium, and tritium, and is about 10 billion times a density of plasma, which greatly increases a probability of nucleus-nucleus collision to produce nuclear fusion, thereby improving the probability of a reaction and reducing the difficulty of nuclear fusion.
2. High-energy neutron current of 1.2 MeV or above is employed to continuously bombard the densely confined static deuteron nuclei within the deuterium alloy reactor, thereby persistently generating high-energy deuterons with energies exceeding 1.2 MeV This process maintains the temperature in the fusion reaction zone (subjected to continuous bombardment by the ≥1.2 MeV neutron current) sustainably above 14 billion ° C. The high-energy deuterons (≥1.2 MeV) violently and continuously collide with the statically confined deuteron nuclei in the alloy reactor, overcoming Coulomb repulsion and sustaining nuclear fusion reactions. As a result, the nuclear fusion process proceeds in a sustained and stable manner.
3. The method and device for nuclear fusion with a deuterium alloy reactor overcomes the limitations of traditional controlled nuclear fusion, where self-sustaining reactions are disrupted due to low deuteron density in plasma and temperature drops, as well as the excessive energy consumption associated with heating the entire fusion device to temperatures above 100 million degrees Celsius required in conventional approaches. It significantly enhances the Q-value and stability of nuclear fusion reactions.
4. By utilizing a boron carbide control rod to regulate the rate and intensity of high-energy neutron current generation, the reaction speed of the nuclear fusion process is further controlled. This enables manageable energy output from the fusion reaction, facilitating the commercial deployment of nuclear fusion power generation.

### BRIEF DESCRIPTION OF THE DRAWINGS

FIG. 1 is an overall structure diagram of a device for nuclear fusion with a deuterium alloy reactor provided in the disclosure.

FIG. 2 is a structure diagram of a high-energy neutron generator unit in the embodiment shown in FIG. 1.

FIG. 3 is a structure diagram of a proton source in the embodiment shown in FIG. 2.

FIG. 4 is a working principle diagram of the proton source in the embodiment shown in FIG. 2.

FIG. 5 is a structure diagram of an alloy reactor unit and an energy conversion unit in the embodiment shown in FIG. 1.

### DETAILED DESCRIPTION OF THE EMBODIMENTS

The disclosure is further described below with reference to examples.

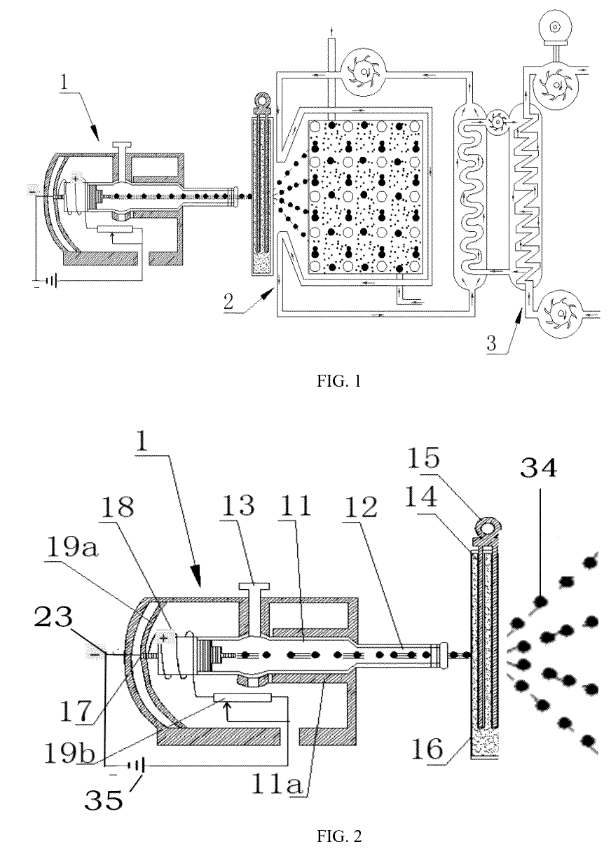

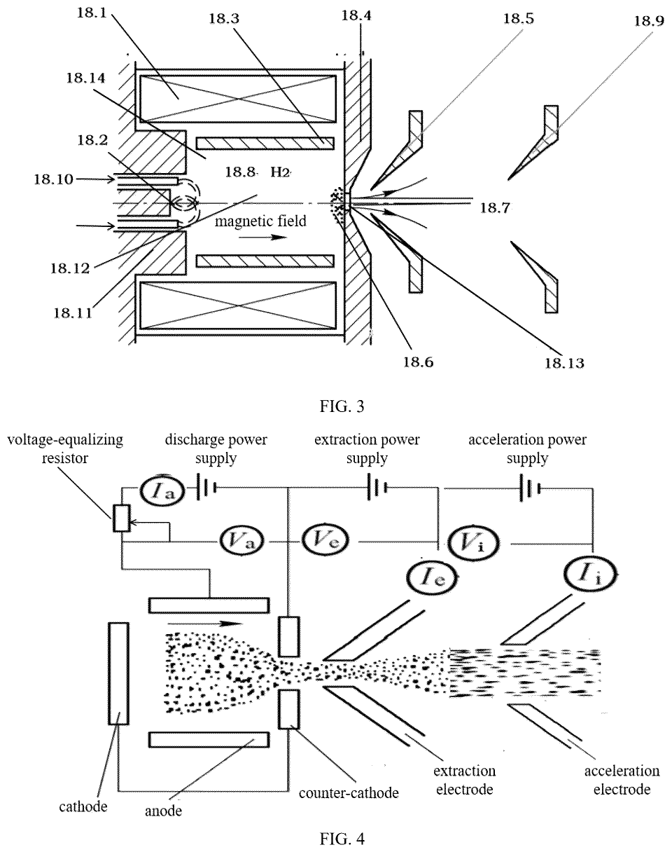

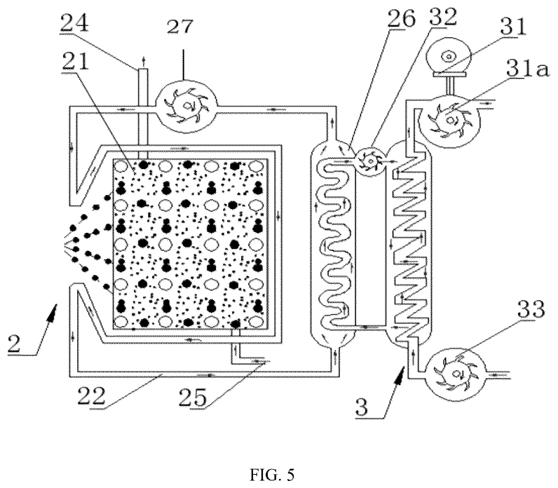

As shown in FIG. 1 to FIG. 5, in FIG. 3, 27 represents a cooling water pump, 32 represents a circulating water pump, and 33 represents a water feeding pump. A device for nuclear fusion with a deuterium alloy reactor is provided, including: a high-energy neutron generator unit 1, configured to generate a high-energy neutron current; alloy reactor unit 2 configured to store hydrogen, deuterium, and tritium gases to produce a deuterium alloy reactor and to allow a nuclear fusion reaction; and energy conversion unit 3 configured to convert energy generated by the nuclear fusion reaction into usable energy.

The high-energy neutron generator unit 1 includes proton source 18, acceleration tube 11, clustering tube 12, vacuum valve 13, metal target 14, and control rod 15. The proton source 18 includes a discharge tube 18.14 and a discharge power supply 35. The left end of the discharge tube is equipped with an insulating base 18.11 and an H₂ inlet hole 18.10 (i.e., H₂ inlet pipe). Hydrogen gas is injected into the ionization cavity 18.12 through the inlet hole 18.10. A tungsten filament cathode 18.2 is axially mounted in the insulating base 18.11. The right end of the discharge tube 18.14 is provided with a counter-cathode 18.4, which has a proton extraction hole 18.13 at its central axis. An extraction electrode 18.5 is sequentially arranged to the right of the proton extraction hole 18.13. The wall of the discharge tube 18.14 serves as an anode tube wall 18.3, and the inner cavity of the discharge tube 18.14 forms the ionization cavity 18.12. Electromagnetic coils 18.1 are wound around the exterior of the discharge tube 18.14, generating an electromagnetic field with magnetic field lines directed to the right when energized. The positive and negative terminals of the discharge power supply 35 are connected to a voltage-equalizing resistor 19b and the tungsten filament cathode 18.2, respectively, forming an ignition circuit. When the ignition circuit is energized, the tungsten filament cathode 18.2 heats up, initiating glow discharge that ionizes H₂ into electrons and protons. The positive and negative terminals of the discharge power supply 35 are also connected to the anode tube wall 18.3 and the counter-cathode 18.4, respectively, forming a discharge circuit. The ignition circuit and the discharge circuit are connected in parallel between the positive and negative terminals of the discharge power supply 35.

The protons generated by the glow discharge converge toward the counter-cathode 18.4 at the right end of the ionization cavity 18.12 under the influence of the electric field force. Simultaneously, the electrons produced by the glow discharge are subjected to both the electric field force directed toward the anode tube wall 18.3 and the Lorentz force induced by the magnetic field, causing them to undergo helical motion within the discharge tube. This motion repeatedly collides with hydrogen nuclei, ionizing additional protons. These protons, under the electric field force, converge toward the counter-cathode 18.4 at the right end of the ionization cavity 18.12. The protons generated via ionization in the discharge tube 18.14 are extracted through the proton extraction hole 18.13 and formed into a proton beam under the action of the extraction electrode 18.5.

To the right of the extraction electrode 18.5, an acceleration tube 11, a clustering tube 12, an emission end, and a target metal 14 are sequentially arranged. A control rod 15 is inserted into the target metal 14. A vacuum valve 13 is installed on the acceleration tube 11 to evacuate it. The inner diameter of the clustering tube 12 is smaller than that of the acceleration tube 11. The protons ionized by the proton source 18 are extracted through the proton extraction hole under the influence of the extraction electrode, forming a proton beam. This beam is accelerated by the acceleration tube 11 to the right, then bunched by the clustering tube 12 to form a high-energy proton beam. The beam is emitted from the right end and strikes the target metal 14, generating a high-energy neutron current. The control rod 15, inserted into the target metal 14, regulates the intensity and rate of the high-energy neutron current by adjusting its depth of insertion into the target metal.

The proton source 18 is used to ionize H₂ to produce protons. The proton stream is accelerated by the acceleration tube 11, focused by the clustering tube 12, and directed onto the target metal 14 to generate a high-energy neutron current 34. When the energy of the high-energy protons is 2.8 MeV, the energy of the produced high-energy neutrons is 1.2 MeV, and the number of high-energy neutrons generated is 4.35×10⁴. The control rod 15 is used to regulate the rate and intensity of the high-energy neutron current 34 produced by the target metal 14, thereby controlling the intensity of the controllable nuclear fusion reaction.

In the high-energy neutron generator unit 1, the proton source 18 ionizes H₂ to produce protons. These protons pass sequentially through the acceleration tube 11 and the clustering tube 12. When the high-energy proton beam, formed after acceleration by the acceleration tube 11, strikes the target metal 14, the target metal 14 emits a dense high-energy neutron current 34 into the deuterium alloy reactor 21 within the deuterium alloy reactor unit 2.

The deuterium alloy reactor unit 2 includes deuterium alloy reactor 21, cooling liquid loop 22, and heat exchanger 26, where the alloy reactor is made of a deuterium storage alloy and an additive; the alloy reactor is provided with helium exhaust port 24 and gas feed port 25, and the gas feed port is configured to add deuterium gas raw materials; the alloy reactor stores deuterium gas to produce a deuterium alloy reactor. The deuterium alloy reactor 21 is designed for the dense storage of deuterium gas. Taking lithium deuteride as an example, one cubic meter of lithium deuteride alloy contains approximately 5.43×10⁴ moles of lithium metal atomic nuclei. Each mole of lithium metal atomic nuclei can store two moles of deuterium gas, resulting in a total storage capacity of 1.086×10⁵ moles of deuterium gas. This achieves a density 10 billion times greater than that of the plasma in tokamak devices. A cooling liquid loop 22 is installed around the deuterium alloy reactor 21 to facilitate cooling and energy collection. A heat exchanger 26 is integrated into the cooling liquid loop 22 to transfer the collected energy to the energy conversion unit 26.

The high-energy neutron current 34 produced by the high-energy neutron generator unit 1 bombards the deuterium alloy reactor 21 within the deuterium alloy reactor unit 2. When the deuteron nuclei in the deuterium alloy reactor 21 are struck, they form 1.2 MeV high-energy deuterons. These high-energy deuterons collide with the statically confined deuteron nuclei densely constrained within the deuterium alloy reactor 21, overcoming the Coulomb barrier and initiating nuclear fusion reactions.

Further, a metal protective film 16 is applied to the surface of the target metal 14, and the control rod 15 is made of boron carbide.

Further, the proton source 18 is equipped with a discharge power supply 35 and a voltage-equalizing resistor 19b, allowing adjustment of the discharge voltage level via the voltage-equalizing resistor 19b.

Further, the proton source 18 includes a high-voltage terminal shell 19a, a tungsten filament cathode 18.2, and a counter-cathode 18.4. The acceleration tube 11 is further provided with water-cooled coil 11a for shell cooling.

Further, the energy conversion unit 3 is provided with steam engine 31, and the steam engine includes steam generator 31a; and the energy conversion unit collects heat energy generated by nuclear fusion through the heat exchanger and cools a deuterium alloy reactor, then converts the collected heat energy into water vapor through the steam generator, and drives the steam engine to generate electricity through the water vapor, such that the heat energy is converted into electric energy.

Further, a tungsten steel alloy is adopted as a protective shell of the alloy reactor 21.

Further, the metal target 14 is a Be target, a W target, or a Hg target.

A method for nuclear fusion with a deuterium alloy reactor is provided, including the following steps:
(1) Li or Er is selected as the hydrogen storage alloy, and one or more additives from Cr, Fe, Mn, Co, Ni, and Cu are chosen. The reaction chamber is filled with an inert gas, and lithium or erbium metal powder is placed inside. The inert gas is gradually evacuated and replaced with deuterium gas. Under specific pressure and temperature conditions, the lithium or erbium metal powder is fully reacted with deuterium gas to form lithium (or erbium) deuteride alloy. The lithium (or erbium) deuteride alloy is then added to lithium (or erbium) deuteride alloy modules to fabricate the deuterium alloy nuclear fusion reactor.
(2) Protons are generated by ionizing H₂ in the discharge tube 18.14 of the proton source 18. The protons are accelerated through the acceleration tube 11 and focused by the clustering tube 12 to form a high-energy proton beam, which bombards the target metal 14. A vacuum valve 13 is installed on the acceleration tube 11 to evacuate it. A control rod 15 is inserted into the target metal 14. The protons are accelerated and bunched to form a high-energy proton beam, which strikes the target metal 14 to produce a high-energy neutron current 34 with energy exceeding 1.2 MeV The control rod 15, made of boron carbide, is embedded in the target metal 14. The intensity of the high-energy neutron current is regulated by adjusting the insertion depth of the control rod 15 into the target metal 14.
(3) The accelerated and bunched high-energy proton beam bombards the target metal 14, producing a high-energy neutron current 34 with energy above 1.2 MeV This neutron current is directed into the deuterium alloy reactor 21 from step (1), where it strikes the deuteron nuclei within the reactor to generate 1.2 MeV high-energy deuterons. These high-energy deuterons violently collide with the statically confined deuterons densely constrained in the deuterium alloy, overcoming Coulomb repulsion and initiating nuclear fusion reactions. The control rod 15, made of boron carbide and inserted into the target metal 14, is used to control the rate and intensity of the high-energy neutron current 34 by adjusting its insertion depth, thereby regulating the intensity of the controllable nuclear fusion reaction.
(4) A cooling liquid loop 22 is installed around the deuterium alloy reactor 21 to cool the system and collect the energy generated by the nuclear fusion reactions. The energy is transferred to the energy conversion unit 3 via a heat exchanger 26 integrated into the cooling liquid loop 22.
(5) The energy generated by the nuclear fusion reaction in step (4) is converted into usable energy by an energy conversion unit 3.

Further, in the step (1), the Li or Er metal powder reacts with the deuterium gas to form the lithium deuteride alloy or the erbium deuteride alloy, with the respective reaction equations as follows:

$$\begin{matrix}2 \times {}_{3}^{6} ∠ i + {}_{1}^{2} {H}_{2} \to 2 \times {}_{3}^{6} ∠ i {}_{1}^{2} H ; or \\ 2 \times {}_{68}^{167} Er + 3 \times {}_{1}^{2} {H}_{2} \to 2 \times {}_{68}^{167} {Er}_{1}^{2} H 3.\end{matrix}$$

The nuclear fusion reaction is specifically as follows:

In the lithium deuteride alloy reactor, equations of the nuclear fusion reaction are as follows:

$$2 {\times }_{3}^{6} < i + {}_{1}^{2} {H}_{2} \to 2 {\times }_{3}^{6} < {i}_{1}^{2} H \qquad 1$$

$${}_{0}^{1} n + {}_{3}^{6} Li \to {}_{2}^{4} He + {}_{1}^{3} H + 4.8 MeV \qquad 2$$

$${}_{1}^{2} H + {}_{1}^{3} H {\to }_{2}^{4} He + {}_{0}^{1} n + 17.6 MeV \qquad 3$$

$${}_{1}^{2} H + {}_{1}^{2} H {\to }_{1}^{3} H + {}_{1}^{1} H + 3.37 MeV \qquad 4$$

$${}_{0}^{1} n + {}_{3}^{6} Li \to {}_{2}^{4} He + {}_{1}^{3} H + 4.8 MeV \qquad 5$$

$${}_{1}^{2} H + {}_{3}^{6} < i \to 2 {\times }_{2}^{4} He + 22.4 {M}_{e} V \qquad 6$$

$${}_{1}^{2} H + {}_{2}^{3} He {\to }_{2}^{4} He + {}_{1}^{1} H + 18.14 MeV \qquad 7$$

$${}_{1}^{2} H + {}_{1}^{2} H {\to }_{2}^{3} He + {}_{0}^{1} n + 3.37 MeV \qquad 8$$

In the erbium deuteride alloy reactor, equations of the nuclear fusion reaction are as follows:

$$2 {\times }_{68}^{167} Er + 3 {\times }_{1}^{2} {H}_{2} \to 2 {\times }_{68}^{167} Er {}_{1}^{2} H 3 \qquad 1$$

$${}_{1}^{2} H + {}_{1}^{2} H {\to }_{2}^{3} He + {}_{0}^{1} n + 3.37 MeV \qquad 2$$

$${}_{1}^{2} H + {}_{2}^{3} He {\to }_{2}^{4} He + {}_{1}^{1} H + 18.14 MeV \qquad 3$$

$${}_{1}^{2} H + {}_{1}^{3} H {\to }_{2}^{4} He + {}_{0}^{1} n + 17.6 MeV \qquad 4$$

$${}_{1}^{2} H + {}_{1}^{2} H {\to }_{1}^{3} H + {}_{1}^{1} P + 4.04 MeV \qquad 5$$

$${}_{68}^{167} Er + {}_{1}^{1} P \to {}_{68}^{167} Tm . \qquad 6$$

Further, the control rod 15 in step (1) is a boron carbide control rod.

Further, the deuterium storage alloy and the additive in step (1) may be adopted in any ratio, and the deuterium alloy reactor 21 can adjust the abundance of the stored deuterium nuclei according to the speed requirements of the nuclear fusion reaction.

### I. For the Lithium Deuteride Alloy Reactor

Based on the principles of the hydrogen bomb explosion process and using lithium deuteride alloy as an example, the nuclear fusion reaction process of this alloy reactor is described: Lithium deuteride alloy (hydrogen bomb material) densely confines deuteron nuclei within the lithium metal lattice. A high-energy neutron current above 1.2 MeV, produced by the aforementioned high-energy neutron generator unit, bombards the deuterium alloy reactor. The deuteron nuclei in the deuterium alloy are struck by high-energy neutrons, generating 1.2 MeV high-energy deuterons. These 1.2 MeV high-energy deuterons violently collide with the statically confined deuteron nuclei and lithium nuclei in the lithium deuteride alloy, as well as with the high-energy tritium nuclei subsequently generated by the fusion reactions, thereby overcoming Coulomb repulsion and initiating nuclear fusion. The entire process and its reaction equations are as follows.
\textcircled{1} Preparation of lithium-deuterium alloy: Under an inert gas atmosphere, deuterium gas and lithium metal (/i-6) are introduced into the reaction chamber. Under specific temperature and pressure conditions, the inert gas is evacuated and replaced with deuterium gas. After several hours of reaction, solid “lithium deuteride alloy” material is synthesized. This alloy exhibits extremely high deuterium storage capacity, with deuterium accounting for up to 22.48% of its mass. The reaction process is as follows:

$$2 {\times }_{3}^{6} < i + {}_{1}^{2} {H}_{2} \to 2 {\times }_{3}^{6} < {i}_{1}^{2} H .$$

\hat{2} A high-energy neutron current with energy exceeding 1.2 MeV bombards the lithium nuclei in the lithium deuteride alloy, producing helium-4 and 1.2 MeV high-energy tritium nuclei, while releasing 4.8 MeV of energy. The reaction is as follows:

$${}_{0}^{1} n + {}_{3}^{6} Li \to {}_{2}^{4} He + {}_{1}^{3} H + 4.8 MeV .$$

\textcircled{3} High-energy neutrons with energy above 1.2 MeV strike the deuteron nuclei in the lithium deuteride alloy, continuously generating 1.2 MeV high-energy deuterons. These high-energy deuterons violently collide with the high-energy tritium nuclei produced by the aforementioned nuclear reactions, overcoming the Coulomb barrier and initiating nuclear fusion reactions. This process produces helium-4 and high-energy neutrons with energy exceeding 1.2 MeV, while releasing immense energy. The reaction is as follows:

$${}_{1}^{2} H + {}_{1}^{3} H {\to }_{2}^{4} He + {}_{0}^{1} n + 17.6 MeV .$$

\textcircled{4} High-energy deuterons violently collide with the densely arranged static deuteron nuclei in the lithium deuteride alloy, overcoming the Coulomb barrier and initiating nuclear fusion reactions. This produces helium-3 and high-energy protons with energy above 1.2 MeV, while releasing immense energy. The reaction is as follows:

$${}_{1}^{2} H + {}_{1}^{2} H {\to }_{1}^{3} H + {}_{1}^{1} H + 3.37 MeV .$$

\textcircled{5} High-energy deuterons violently collide with the tritium nuclei generated by the aforementioned nuclear fusion reactions, producing helium-4 and high-energy neutrons with energy exceeding 1.2 MeV, while releasing immense energy. The reaction is as follows:

$${}_{1}^{2} H + {}_{1}^{3} H {\to }_{2}^{4} He + {}_{0}^{1} n + 17.6 MeV .$$

\textcircled{6} High-energy neutrons with energy above 1.2 MeV strike the deuteron nuclei in the lithium deuteride alloy, continuously generating 1.2 MeV high-energy deuterons. These high-energy deuterons repeatedly collide with the statically confined deuteron nuclei densely bound in the lithium deuteride alloy, producing high-energy helium-3 and high-energy neutrons with energy exceeding 1.2 MeV, while releasing immense energy. The reaction is as follows:

$${}_{1}^{2} H + {}_{1}^{2} H {\to }_{2}^{3} He + {}_{0}^{1} n + 3.37 MeV .$$

\textcircled{7} A high-energy neutron current with energy above 1.2 MeV bombards the lithium nuclei in the “lithium deuteride” alloy, generating high-energy tritium nuclei with energy exceeding 1.2 MeV and helium-4, while releasing immense energy. The reaction is as follows:

$${}_{0}^{1} n + {}_{3}^{6} Li \to {}_{2}^{4} He + {}_{1}^{3} H + 4.8 MeV .$$

\textcircled{8} High-energy deuterons violently collide with the high-energy tritium nuclei produced by the aforementioned nuclear fusion reactions, overcoming the Coulomb repulsion and initiating nuclear fusion reactions. This process produces helium-4 and high-energy neutrons with energy above 1.2 MeV, while releasing immense energy. The reaction is as follows:

$${}_{1}^{2} H + {}_{1}^{3} H {\to }_{2}^{4} He + {}_{0}^{1} n + 17.6 MeV .$$

\textcircled{9} High-energy deuterons violently collide with lithium nuclei, overcoming the Coulomb barrier and initiating nuclear fusion reactions, directly fusing into helium-4 atomic nuclei and releasing immense energy. The reaction is as follows:

$${}_{1}^{2} H + {}_{3}^{6} < i \to 2 {\times }_{2}^{4} He + 22.4 {M}_{e} V .$$

In this way, the nuclear fusion reaction can proceed stably. By adjusting the velocity and intensity of the high-energy neutron current generated by the compact proton accelerator, as well as modulating the abundance of deuterium-lithium nuclei in the lithium deuteride, the rate of the nuclear fusion reaction can be controlled, enabling relatively stable operation of the fusion process.

### II. For the Erbium Deuteride Alloy Reactor

Taking NASA's erbium deuteride lattice confinement experiment as an example, the nuclear fusion reaction process in an erbium deuteride alloy reactor using metal Er as raw material is described below.
\textcircled{1} Preparation of erbium deuteride alloy: Under an inert gas atmosphere, deuterium gas and erbium metal powder (Er-167) are introduced into the reaction chamber. Under controlled conditions, the inert gas is evacuated and replaced with deuterium gas to synthesize solid erbium deuteride material. The reaction is as follows:

$$2 {\times }_{68}^{167} Er + 3 {\times }_{1}^{2} {H}_{2} \to 2 {\times }_{68}^{167} Er {}_{1}^{2} H 3.$$

\textcircled{2} The statically confined deuteron nuclei densely constrained in the erbium deuteride alloy pile are bombarded by a high-energy neutron beam above 1.2 MeV produced by a compact proton accelerator, generating high-energy deuterons above 1.2 MeV. When these high-energy deuterons violently collide with the statically confined deuteron nuclei densely constrained in the erbium deuteride alloy pile, they overcome Coulomb repulsion and initiate nuclear fusion reactions, simultaneously producing helium-3 and high-energy neutrons with energy exceeding 1.2 MeV, while releasing immense energy. The reaction process is as follows:

$${}_{1}^{2} H + {}_{1}^{2} H {\to }_{2}^{3} He + {}_{0}^{1} n + 3.37 MeV .$$

\textcircled{3} High-energy deuterons violently collide with the helium-3 nuclei produced by the aforementioned nuclear fusion, generating helium-4 and high-energy protons while releasing substantial energy. The reaction is as follows:

$${}_{1}^{2} H + {}_{2}^{3} He {\to }_{2}^{4} He + {}_{1}^{1} H + 18.14 MeV .$$

\textcircled{4} High-energy deuterons continuously collide with the statically confined deuteron nuclei highly constrained in the erbium deuteride lattice, producing high-energy tritium nuclei and high-energy protons with energy exceeding 1.2 MeV, while releasing immense energy. The reaction is as follows:

$${}_{1}^{2} H + {}_{1}^{2} H {\to }_{1}^{3} H + {}_{1}^{1} P + 4.04 MeV .$$

\textcircled{5} High-energy deuterons violently collide with the high-energy tritium nuclei generated by the aforementioned nuclear fusion reactions, overcoming Coulomb repulsion to initiate nuclear fusion reactions. This produces helium-4 and high-energy neutrons with energy above 1.2 MeV, while releasing immense energy. The reaction is as follows:

$${}_{1}^{2} H + {}_{1}^{3} H \to {}_{2}^{4} He + {}_{0}^{1} n + 17.6 MeV .$$

\textcircled{6} High-energy deuterons violently collide with the statically confined deuteron nuclei densely constrained in the erbium deuteride lattice, producing helium-3 and high-energy neutrons with energy exceeding 1.2 MeV, while releasing immense energy. The reaction process is as follows

$${}_{1}^{2} H + {}_{1}^{2} H \to {}_{2}^{3} He + {}_{0}^{1} n + 3.37 MeV .$$

\textcircled{7} High-energy deuterons violently collide with the helium-3 nuclei produced by the aforementioned nuclear fusion, generating helium-4 and high-energy protons with energy exceeding 1.2 MeV, while releasing immense energy. The reaction is as follows:

$${}_{1}^{2} H + {}_{2}^{3} H \to {}_{2}^{4} He + {}_{1}^{1} H + 18.14 MeV .$$

\textcircled{8} High-energy deuterons continuously collide with the statically confined deuteron nuclei densely constrained in the erbium deuteride lattice, producing tritium nuclei and high-energy protons while releasing substantial energy. The reaction is as follows:

$${}_{1}^{2} H + {}_{1}^{2} H \to {}_{1}^{3} H + {}_{1}^{1} P + 4.04 MeV .$$

\textcircled{9} If erbium captures the protons produced by the aforementioned nuclear fusion reactions, thulium is generated. The reaction is as follows:

$${}_{68}^{167} Er + {}_{1}^{1} P \to {}_{69}^{169} Tm .$$

\textcircled{10} High-energy deuterons violently collide with the high-energy tritium nuclei generated by the aforementioned nuclear fusion reactions, overcoming Coulomb repulsion to initiate nuclear fusion reactions. This produces helium-4 and high-energy neutrons with energy above 1.2 MeV, while releasing immense energy. The reaction is as follows:

$${}_{1}^{2} H + {}_{1}^{3} H \to {}_{2}^{4} He + {}_{0}^{1} n + 17.6 MeV .$$

Through such continuous cycles, the nuclear fusion reaction can proceed sustainably. By adjusting the velocity and intensity of the high-energy neutron current generated by the compact proton accelerator, as well as modulating the abundance of deuteron nuclei in the erbium deuteride, the rate of the nuclear fusion reaction can be controlled, enabling stable operation of the fusion process.

The scientific practice of human hydrogen bomb explosions and NASA's scientific discovery of lattice confinement nuclear fusion demonstrate that by using a compact proton accelerator to generate a high-energy neutron current above 1.2 MeV to continuously bombard the statically confined deuteron nuclei densely constrained in the deuterium alloy reactor, 1.2 MeV high-energy deuterons can be persistently generated. This process maintains the temperature in the fusion reaction zone of the deuterium alloy pile at and sustainably stabilizes it above 14 billion degrees Celsius. These high-energy deuterons violently collide with the statically confined deuteron nuclei densely constrained in the deuterium alloy reactor, overcoming Coulomb repulsion and sustaining nuclear fusion reactions. This method, which employs a high-energy neutron current above 1.2 MeV to continuously bombard the statically confined deuteron nuclei in the deuterium alloy pile, persistently generates high-energy deuterons above 1.2 MeV It maintains the temperature in the fusion reaction zone (subjected to continuous bombardment by the ≥1.2 MeV neutron current) sustainably above 14 billion degrees Celsius. The 1.2 MeV high-energy deuterons continuously and violently collide with the statically confined deuteron nuclei in the deuterium alloy pile, repeatedly overcoming Coulomb repulsion to initiate nuclear fusion reactions, thereby enabling stable operation of the fusion process. The disclosure overcomes the limitations of traditional controlled nuclear fusion, where self-sustaining fusion reactions are disrupted due to the low density of deuteron nuclei in plasma and temperature drops. It also addresses the excessive energy consumption associated with heating the entire fusion device to temperatures above 100 million degrees Celsius, as required in conventional approaches. The “deuterium alloy nuclear fusion reactor technology and device” described in the disclosure significantly enhances the Q-value and stability of nuclear fusion reactions, demonstrating substantial application prospects.

The disclosure is described in detail above. The above are merely preferred examples of the disclosure, and do not limit the implementation scope of the disclosure, that is, any addition, subtraction, or replacement of a general technical means made within the scope of the present application shall fall within the scope of the disclosure.

What is claimed is:

1. A device for a nuclear fusion with a deuterium alloy reactor, comprising:
a high-energy neutron generator unit, configured to generate a high-energy neutron current;
an alloy reactor unit, configured to store a deuterium gas to produce the deuterium alloy reactor and to allow a nuclear fusion reaction;
an energy conversion unit, configured to convert an energy generated by the nuclear fusion reaction into a usable energy,
wherein the neutron generator unit comprises a proton source, an acceleration tube, a clustering tube, a vacuum valve, a target metal, and a control rod;
the proton source comprises a discharge tube in a cylindrical shape, a left end of the discharge tube is fixed with an insulating base and a hydrogen gas inlet pipe, a central axis position of the insulating base is disposed with a tungsten filament cathode, a right end of the discharge tube is sequentially disposed with a counter-cathode, an extraction electrode, and an acceleration electrode; a central axis of the counter-cathode is defined with a proton extraction hole, a wall of the discharge tube is disposed as an anode with electromagnetic coils therearound configured to generate an axial magnetic field directed to right when powered; a discharge power supply and a voltage-equalizing resistor are connected between the tungsten filament cathode and the anode, and the voltage-equalizing resistor is configured to adjust a discharge voltage; when the tungsten filament cathode is powered and heated, the tungsten filament cathode is configured to ionize hydrogen gas entering the discharge tube to produce glow discharge to thereby generate electrons and protons; the protons converge into a proton beam towards the proton extraction hole defined at the central axis of the counter-cathode under an action of an electric field force; the electrons are attracted by a radial electric field force of the anode and simultaneously influenced by an electromagnetic force of a magnetic field directed to the right, to thereby move in a spiral coil motion towards the wall of the of the discharge tube; during the spiral coil motion of the electrons, the electrons are configured to collide with more hydrogen atomic nuclei to ionize more protons and then converge into the proton beam towards the proton extraction hole defined at the central axis of the counter-cathode;
a left end of the acceleration tube is sequentially connected to the extraction hole and extraction electrode on the central axis of the counter-cathode, a right end of the acceleration tube is connected to the clustering tube, the left end and the right end of the acceleration tube are respectively connected to positive and negative poles of an acceleration power supply, and the acceleration power supply is configured to provide an acceleration voltage; the protons enter the acceleration tube through the proton extraction hole and the extraction electrode, and under an action of an electric field force of the acceleration electrode, the protons are accelerated to above 2.8 mega-electron volts (MeV) to form high-energy protons;
a left end of the clustering tube is connected to the acceleration tube, and a right end of the clustering tube is set as an emission end and is disposed with the target metal, the clustering tube is disposed with an electromagnetic lens coil therearound, and the clustering tube is configured to generate a clustering magnetic field when powered to further focus the high-energy protons formed by the acceleration tube to obtain a high-energy proton beam to thereby impact the target metal located at the right end of the clustering tube, so as to produce the high-energy neutron current of over 1.2 MeV; the protons produced by the proton source sequentially pass through the extraction hole, the acceleration tube, the clustering tube, the emission end, and the target metal from left to right; the acceleration tube and the clustering tube are equipped with the vacuum valve configured to evacuate the acceleration tube to a vacuum state; an inner diameter of the clustering tube is smaller than that of the acceleration tube; the high-energy protons generated by the proton source is accelerated through the acceleration tube and focused by the clustering tube to form the high-energy proton beam; the target metal is set at a right end of the emission end of the clustering tube;
a right end of the target metal is equipped with the deuterium alloy reactor, the high-energy neutron current generated by the high-energy neutron generator unit bombards densely stored deuterium nuclei in the deuterium alloy reactor to generate high-energy deuterium nuclei of 1.2 MeV; the high-energy deuterium nuclei collide with tightly confined static deuterium nuclei in the deuterium alloy reactor, quickly overcome a Coulomb barrier and undergo a nuclear fusion reaction to produce high-energy tritium nuclei, thereby releasing energy; and the high-energy deuterium nuclei further collide violently with the high-energy tritium nuclei produced by the nuclear fusion reaction, overcome the Coulomb barrier to continue the nuclear fusion reaction and release energy; and
the deuterium alloy reactor unit comprises the deuterium alloy reactor, a cooling liquid loop, and a heat exchanger; the deuterium alloy reactor is made of deuterium storage alloy and an additive; a bottom of the deuterium alloy reactor is defined with a helium exhaust port, and a top of the deuterium alloy reactor is defined with a gas feed port configured to add deuterium gas raw materials; after storing deuterium gas, the deuterium alloy reactor forms deuterium alloy reactor modules, the deuterium alloy reactor modules are arranged to move to be sequentially struck by the high-energy neutron current, thereby producing the nuclear fusion reaction; the cooling liquid loop is disposed at a front side, a rear side, and a right side of the deuterium alloy reactor unit to prevent the deuterium alloy reactor modules from overheating and is configured to cool down and collect the energy; and the heat exchanger is disposed on the cooling liquid loop and configured to transfer the energy to the energy conversion unit.

2. The device for the nuclear fusion with the deuterium alloy reactor according to claim 1, wherein the deuterium alloy is prepared using lithium (Li) or erbium (Er); and the additive comprises one or more selected from the group consisting of chromium (Cr), iron (Fe), manganese (Mn), cobalt (Co), nickel (Ni), and copper (Cu).

3. The device for the nuclear fusion with the deuterium alloy reactor according to claim 1, wherein a surface of the metal target is provided with a metal protective film; the control rod is a boron carbide control rod.

4. The device for the nuclear fusion with the deuterium alloy reactor according to claim 3, the control rod is inserted into the target metal and is configured to control speed and intensity of the high-energy neutron current by adjusting a depth of insertion of the control rod into the target metal.

5. The device for the nuclear fusion with the deuterium alloy reactor according to claim 1, wherein the proton source is provided with the discharge power supply configured to produce a pulsed proton current.

6. The device for the nuclear fusion with the deuterium alloy reactor according to claim 1, wherein the proton source comprises a terminal shell, the voltage-equalizing resistor, the discharge power supply, and the tungsten filament cathode; and the voltage-equalizing resistor is connected in series to a positive circuit of the discharge power supply.

7. The device for the nuclear fusion with the deuterium alloy reactor according to claim 1, wherein the acceleration tube is disposed with the acceleration electrode, the clustering tube is configured to further focus the high-energy protons to obtain the high-energy proton beam, and the clustering tube and the acceleration tube are provided with a water-cooled coil for shell cooling.

8. The device for the nuclear fusion with the deuterium alloy reactor according to claim 1, wherein the target metal is one of beryllium (Be), tungsten (W), and mercury (Hg); and when the high-energy proton beam bombards a Be target, a W target, or a Hg target, the high-energy neutron current of over 1.2 MeV is generated.

9. The device for the nuclear fusion with the deuterium alloy reactor according to claim 8, wherein the target metal is the Be target, when the high-energy proton beam bombards the Be target, the corresponding nuclear reaction equation is as follows:
high-energy proton bombardment of the Be target:
$${}_{1}^{1} H + {}_{4}^{9} Be \to {}_{5}^{9} B + {}_{0}^{1} n .$$

10. The device for the nuclear fusion with the deuterium alloy reactor according to claim 8, wherein the target metal is the W target, when the high-energy proton beam bombards the W target, the corresponding nuclear reaction equation is as follows:
high-energy proton bombardment of the W target:
$${}_{1}^{1} H + {}_{74}^{184} W \to {}_{45}^{103} Rh + {}_{30}^{64} Zn + 18 \times {}_{0}^{1} n .$$

11. The device for the nuclear fusion with the deuterium alloy reactor according to claim 8, wherein the target metal is the Hg target, when the high-energy proton beam bombards the Hg target, the corresponding nuclear reaction equation is as follows:
high-energy proton bombardment of the Hg target:
$$2 \times {}_{1}^{1} H + {}_{80}^{200} Hg \to {}_{56}^{130} Ba + {}_{26}^{54} Fe + 18 \times {}_{0}^{1} n .$$

12. The device for the nuclear fusion with the deuterium alloy reactor according to claim 1, wherein the energy conversion unit is provided with a steam engine, and the steam engine comprises a steam generator; and the energy conversion unit collects a heat energy generated by the nuclear fusion through the heat exchanger and cools the deuterium alloy reactor, then converts the heat energy into a water vapor through the steam generator, and drives the steam engine to generate an electricity through the water vapor, such that the heat energy is converted into an electric energy.

13. A method for a nuclear fusion with a deuterium alloy reactor, comprising the following steps:
(1) taking Li or Er as a deuterium storage alloy, and taking one or more selected from the group consisting of Cr, Fe, Mn, Co, Ni, and Cu as an additive; filling a reaction chamber with inert gas, placing Li or Er metal powder in the reaction chamber, continuously extracting the inert gas and introducing deuterium gas, letting the deuterium gas and the Li or Er metal powder react continuously for several hours under certain temperature and pressure conditions to prepare lithium deuteride alloy or erbium deuteride alloy; and filling the lithium deuteride alloy or the erbium deuteride alloy into deuterium alloy modules to produce a lithium deuteride alloy reactor or an erbium deuteride alloy reactor as the deuterium alloy reactor;
(2) producing a high-energy neutron current by using a high-energy proton beam to bombard a target metal, using the high-energy neutron current to bombard the lithium deuteride alloy reactor or the erbium deuteride alloy reactor in the step (1), such that deuterium nuclei in the deuterium alloy reactor are struck by high-energy neutrons to generate high-energy deuterium nuclei of 1.2 MeV; the high-energy deuterium nuclei collide with tightly confined static deuterium nuclei in the deuterium alloy reactor, quickly overcome a Coulomb barrier and undergo a nuclear fusion reaction; adjusting a depth of a control rod inserted into the target metal to control speed and intensity of the high-energy neutron current generated by the target metal, thereby controlling intensity of the nuclear fusion reaction;
(3) providing a cooling liquid loop outside the deuterium alloy reactor, wherein the cooling liquid loop is configured for cooling, collecting an energy generated by the nuclear fusion reaction, and delivering the energy to an energy conversion unit through a heat exchanger; and
(4) converting the energy generated by the nuclear fusion reaction in step (3) into a usable energy by the energy conversion unit.

14. The method for the nuclear fusion with the deuterium alloy reactor according to claim 13, wherein in the step (1), the Li or Er metal powder reacts with the deuterium gas to form the lithium deuteride alloy or the erbium deuteride alloy, with the respective reaction equations as follows:
$$2 \times {}_{3}^{6} ∠ i + {}_{1}^{2} {H}_{2} \to 2 \times {}_{3}^{6} ∠ i {}_{1}^{2} H ; or$$
$$2 \times {}_{68}^{167} Er + 3 \times {}_{1}^{2} {H}_{2} \to 2 \times {}_{68}^{167} Er {}_{1}^{2} H 3 .$$

15. The method for the nuclear fusion with the deuterium alloy reactor according to claim 13, wherein in the step (2), the target metal is one of a Be target, a W target, and a Hg target; and when the high-energy proton beam bombards the Be target, the W target, or the Hg target, the high-energy neutron current of over 1.2 MeV is generated.

16. The method for the nuclear fusion with the deuterium alloy reactor according to claim 15, wherein the target metal is the Be target, when the high-energy proton beam bombards the Be target, the corresponding nuclear reaction equation is as follows:
high-energy proton bombardment of the Be target:
$${}_{1}^{1} H + {}_{4}^{9} Be \to {}_{5}^{9} B + {}_{0}^{1} n .$$

17. The method for the nuclear fusion with the deuterium alloy reactor according to claim 15, wherein the target metal is the W target, when the high-energy proton beam bombards the W target, the corresponding nuclear reaction equation is as follows:
high-energy proton bombardment of the W target:
$${}_{1}^{1} H + {}_{74}^{184} W \to {}_{45}^{103} Rh + {}_{30}^{64} Zn + 18 \times {}_{0}^{1} n .$$

18. The method for the nuclear fusion with the deuterium alloy reactor according to claim 15, wherein the target metal is the Hg target, when the high-energy proton beam bombards the Hg target, the corresponding nuclear reaction equation is as follows:
high-energy proton bombardment of the Hg target:
$$2 \times {}_{1}^{1} H + {}_{80}^{200} Hg \to {}_{56}^{130} Ba + {}_{26}^{54} Fe + 18 \times {}_{0}^{1} n .$$

19. The method for the nuclear fusion with the deuterium alloy reactor according to claim 13, wherein, in the lithium deuteride alloy reactor, equations of the nuclear fusion reaction are as follows:
$$2 \times {}_{3}^{6} ∠ i + {}_{1}^{2} {H}_{2} \to 2 \times {}_{3}^{6} ∠ i {}_{1}^{2} H \qquad 1$$
$${}_{0}^{1} n + {}_{3}^{6} Li \to {}_{2}^{4} He + {}_{1}^{3} H + 4.8 MeV \qquad 2$$
$${}_{1}^{2} H + {}_{1}^{3} H \to {}_{2}^{4} He + {}_{0}^{1} n + 17.6 MeV \qquad 3$$
$${}_{1}^{2} H + {}_{1}^{2} H \to {}_{1}^{3} H + {}_{1}^{1} H + 3.37 MeV \qquad 4$$
$${}_{0}^{1} n + {}_{3}^{6} Li \to {}_{2}^{4} He + {}_{1}^{3} H + 4.8 MeV \qquad 5$$
$${}_{1}^{2} H + {}_{3}^{6} ∠ i \to 2 \times {}_{2}^{4} He + 22.4 MeV \qquad 6$$
$${}_{1}^{2} H + {}_{2}^{3} He \to {}_{2}^{4} He + {}_{1}^{1} H + 18.14 MeV \qquad 7$$
$${}_{1}^{2} H + {}_{1}^{2} H \to {}_{2}^{3} He + {}_{0}^{1} n + 3.37 MeV . \qquad 8$$

20. The method for the nuclear fusion with the deuterium alloy reactor according to claim 13, wherein, in the erbium deuteride alloy reactor, equations of the nuclear fusion reaction are as follows:
$$2 \times {}_{68}^{167} Er + 3 \times {}_{1}^{2} {H}_{2} \to 2 \times {}_{68}^{167} Er {}_{1}^{2} H 3 \qquad 1$$
$${}_{1}^{2} H + {}_{1}^{2} H \to {}_{2}^{3} He + {}_{0}^{1} n + 3.37 MeV \qquad 2$$
$${}_{1}^{2} H + {}_{2}^{3} He \to {}_{2}^{4} He + {}_{1}^{1} H + 18.14 MeV \qquad 3$$
$${}_{1}^{2} H + {}_{1}^{3} H \to {}_{2}^{4} He + {}_{0}^{1} n + 17.6 MeV \qquad 4$$
$${}_{1}^{2} H + {}_{1}^{2} H \to {}_{1}^{3} H + {}_{1}^{1} P + 4.04 MeV \qquad 5$$
$${}_{68}^{167} Er + {}_{1}^{1} P \to {}_{69}^{169} Tm . \qquad 6$$
